(19) United States
(12) Patent Application Publication
(10) Pub. No.: US 2016/0131804 A1
(43) Pub. Date: May 12, 2016

(54) DISPLAY SYSTEM FOR A COMMUNICATION DEVICE

(71) Applicant: MOTOROLA SOLUTIONS, INC., Schaumburg, IL (US)

(72) Inventors: CHOR CHEOW NG, BUTTERWORTH, PENANG (MY); PETER CHRISTOPHER C. JAN, BUTTERWORTH, PUL (MY); WOOI PING TEOH, GEORGETOWN, PENANG (MY)

(73) Assignee: MOTOROLA SOLUTIONS, INC., Schaumburg, IL (US)

(21) Appl. No.: 14/778,501

(22) PCT Filed: Jul. 22, 2013
(86) PCT No.: PCT/US2013/051438

§ 371 Date: Sep. 18, 2015

(51) Int. Cl. G02B 1/16; G02B 27/00

(52) U.S. Cl. CPC G02B 1/16; G02B 27/0006

(57) ABSTRACT

A display system (200) is provided to withstand high impact in conjunction with electrostatic discharge (ESD) protection. The display system (200) comprises a display lens (205) coated with a layer (220) of electrostatic discharge material. The display system (200) further comprises an inner housing layer (210) formed of an insulative material providing structural support to the display lens (205) and an outer housing layer (215) formed of an antistatic material providing an electrical path for dissipating electrostatic charge accumulated on the display lens (205). A portion of the display lens, formed as a flange (225), is mounted between the inner housing layer and the outer housing layer.

### TECHNICAL FIELD

The present disclosure relates generally to display systems, and more particularly to the lenses used in display systems for communication devices requiring high impact and electrostatic discharge protection.

### BACKGROUND OF THE INVENTION

Communication devices, particularly portable communication devices such as handheld two-way radios, are increasingly being used to transmit critical data in emergency situations typically through the use of a display lens. Since these communication devices may be used under extreme environmental conditions, the display lens needs to be designed to withstand high impact. For example, ATEX certification requires the display lens to withstand a 4J steel ball impact without jeopardizing the sealing performance of the communication device.

FIG. 1 shows a conventional communication device 100 in which a plastic display lens 105 is attached to a plastic housing 110. The communication device 100 is provided with an energy director 120 to attach the plastic display lens 105 to the plastic housing 110 by utilizing ultrasonic and laser welding techniques. The energy director 120 is a feature on the plastic enclosure that is bonded with the plastic lens during ultrasonic welding. However, this conventional approach of attaching the plastic display lens 105 utilizing ultrasonic and laser welding can only withstand up to 4J of impact force. Moreover, in the conventional approach, the ultrasonic welding process used to bond the plastic display lens 105 to the plastic housing 110 may be inconsistent resulting in poor seal quality. Also, for ATEX protection to be achieved in such communication devices, an electrostatic discharge escutcheon 115 is required to provide surface electrostatic discharge (ESD) protection. However, ESD protection achieved by utilizing electrostatic discharge escutcheon 115 is limited by the area and is not feasible for large display products. Another approach to achieve ESD protection is to use carbon-filled polycarbonates in the plastic housing 110. Unfortunately, the use of ultrasonic welding on carbon-filled polycarbonates degrades the bonding quality of normal polycarbonate making it more difficult to attach the plastic display lens 105 to the plastic housing 110.

New standards in the public safety environment are now requiring greater than 4J of impact force protection. The ability to increase impact force protection in conjunction with ESD protection is thus highly desirable.

Accordingly, there is a need for a display system that can withstand an impact force higher than 4J that also provides surface ESD protection.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a conventional display system.

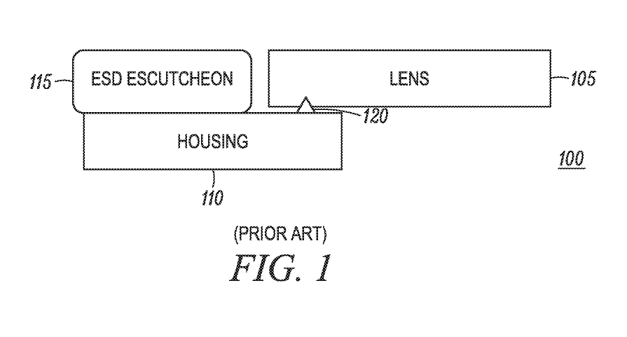

FIG. 2 is a cross-sectional view of a display system formed in accordance with some embodiments.

FIG. 3A is a cross-sectional view illustrating bond formation between a display lens and a first housing layer of the display system in accordance with some embodiments.

FIG. 3B is a cross-sectional view illustrating bond formation between the display lens and a second housing layer of the display system in accordance with some embodiments.

FIG. 4 is a cross-sectional view of the display system illustrating a discharge path for an electrostatic charge accumulated on the surface of the display lens in accordance with some embodiments.

FIG. 5 is a cross-sectional view of the display system receiving a high impact force in accordance with some embodiments.

FIG. 6 shows a pictorial view of a communication device incorporating the display system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Briefly, there is provided herein, a display system comprising a display lens coated with a layer of electrostatic discharge material. The display system further comprises an inner housing layer formed of an insulative material providing structural support to the display lens and an outer housing layer formed of an antistatic material providing an electrical discharge path for discharging a charge accumulated on the display lens. A portion of the display lens is mounted between the inner housing layer and the outer housing layer.

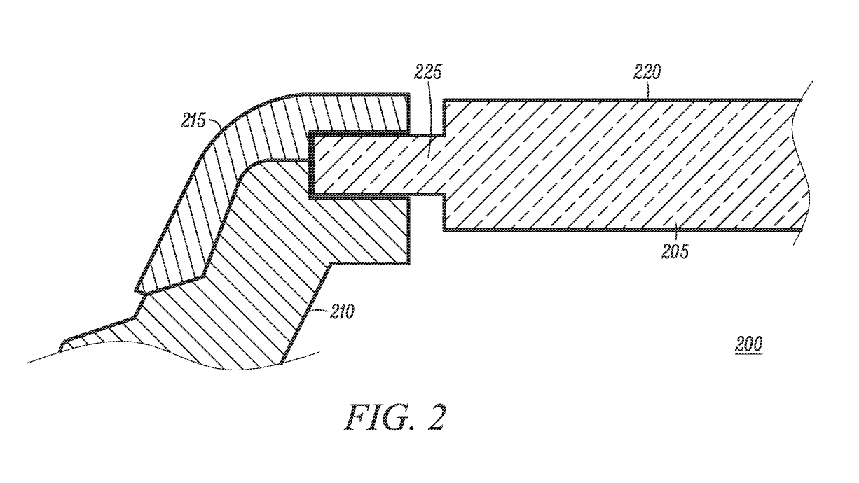

FIG. 2 is a diagram of a cross-sectional view of a display system 200 formed in accordance with some embodiments. The display system 200 includes a display lens 205, a first housing layer 210, and a second housing layer 215. The display lens 205 is coated with a layer of electrostatic discharge (ESD) material 220 for providing an electrically conductive path to allow static charge dissipation from the display lens 205. The electrostatic discharge material coating can be a conductive coating or static dissipative coating having a predetermined surface resistivity in the range of 10²-10¹¹ ohm/sq. The display lens 205 is further provided with a flange 225 about its perimeter. The first housing layer 210 and the second housing layer 215 form a bond about the flange 225. The width of the flange 225 may be selected based on space constraints of the product incorporating the lens, while the thickness of the display lens 205 is based on the size of the display lens 205 being used. In general, the larger the display lens the thicker the lens. In accordance with various embodiments, the display lens 205 protects a liquid crystal display (LCD) of a communication device. The distance between the display lens 205 and the LCD is subject to design parameters such as housing deflection and optical performance.

The first housing layer 210 forms an inner housing of the display system 200 and provides structural support to the display lens 205. The structural support provided by the inner housing can withstand at least an impact force of 7J. The first housing layer 210 of the display system 200 is formed of an insulative material to provide structural support to the display system. The insulative material may be formed of a plastic, such as a polycarbonate or other thermoplastic, capable of being molded using standard molding techniques, such as injection molding or insert molding. The first housing layer 210 provides a robust joint with the display lens 205 to give primary sealing protection to the display system 200 against dust, water and other fluids.

The display lens 205 is a machined piece part formed of a plastic material capable of being molded, such as a transparent thermoplastic polymer based material. The thermoplastic lens becomes pliable or moldable above a specific temperature and return to a solid state after cooling. In accordance with the various embodiments, the lens 205 comprises flange 225 about its perimeter which provides both a means of retention and a gap area for protecting the edges of the display lens 205. A chemical bond is formed between the first and second housing layers and the flange 225.

The second housing layer 215 forms an outer housing of the display system 200. The second housing layer 215 is made of an antistatic material which, in accordance with the various embodiments, provides an electrical bridging path between the display lens 220 and a user's body. The discharge bridge provides a path for dissipating charge accumulated on the display lens 205 by providing a path to ground. In accordance with some embodiments, the antistatic material is an antistatic plastic, a mixture of polycarbonate and carbon powder, or a mixture of polycarbonate and stainless steel filler having a predetermined surface resistivity in range of 10²-10¹¹ ohm/sq. Examples of such plastics, include but are not limited to, polycarbonate (PC), acrylonitrile butadiene styrene (ABS), polycarbonate acrylonitrile butadiene styrene (PC-ABS), and polyoxymethylene (POM) plastic mixed with metal filler of aluminum, carbon, stainless steel, and graphite, to name a few. The metal filler can be in the form of powder or filler. The second housing layer 215 of the display system 200 also provides additional sealing protection to the display system 200 from dust, water and other fluids.

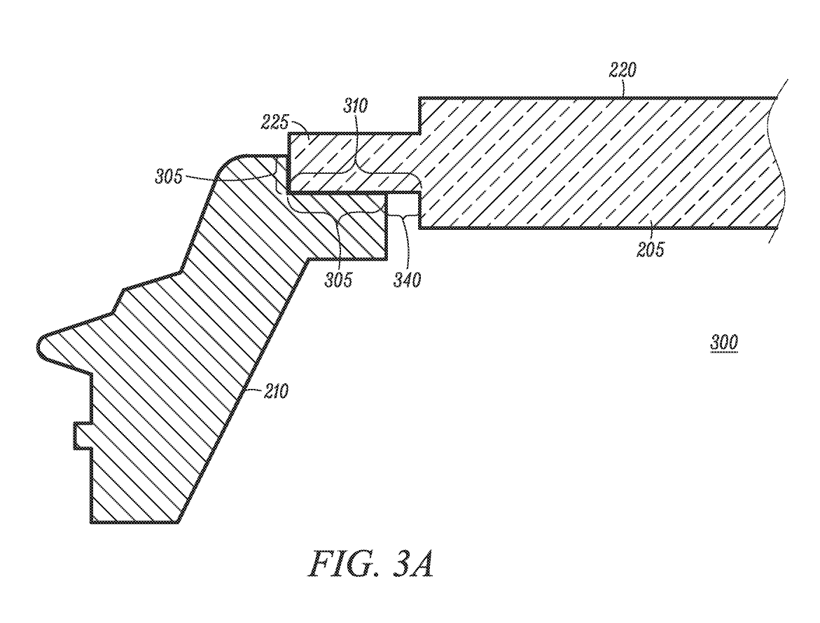

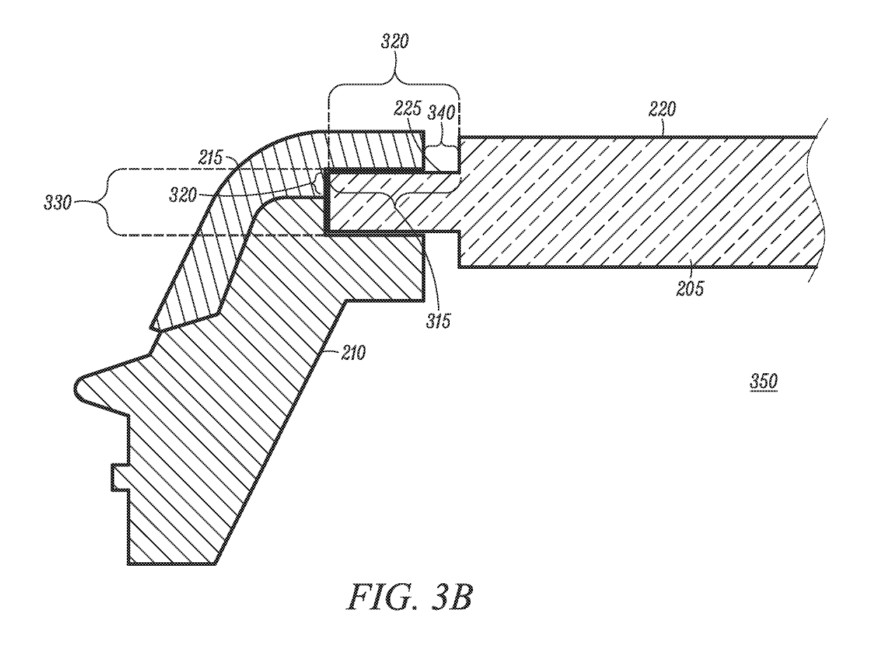

FIG. 3A illustrates bond formation between the display lens 205 and the first housing layer 210 in accordance with some embodiments. The display lens 205, coated with a layer of ESD material 220, is shown inserted into the first housing layer 210. The insertion of the display lens 205 in the first housing layer 210 can be done using various tooling techniques such as insert-molding with dual-shot molding. In accordance with some embodiments, the tooling techniques may include manually or robotically inserting the display lens 205 into the first housing layer 210.

The first housing layer 210 is formed with the display lens 205 attached. A lower cavity portion 305 of the first housing payer 210 provides a shut off surface forming a tight fit for the plastic display lens 205 to hold the part in place before molding. The second housing layer 215 is then molded to the first housing layer 210 and the flange 225 of the display lens 205.

The first housing layer 210 of the display system 200 is designed to provide structural support to the display lens 205 through the incorporation of the lower cavity surface 305. The lower cavity surface 305 retains the lower portion 310 of the flange 225. The lower portion 310 of the flange 225 fits tightly into the lower cavity surface 305 of the first housing layer 210. The lower cavity surface 305 as shown in FIG. 3A holds the lower portion 310 of the flange 225 in place for molding the inserted lower portion 310 of the flange 225 with the first housing layer 210.

In accordance with some embodiments, only a portion of the lower portion 310 of the flange 225, and not the complete lower portion 310 of the flange 225, is inserted into the first housing layer 210 thereby creating a gap 340. The gap 340 prevents damage to the edge(s) of the lens during the molding process which submits the lens to both thermal and mechanical tooling conditions. The molding of the inserted lower portion 310 of the flange 225 with the first housing layer 210 forms a robust bond between the display lens 205 and the first housing layer 210. In accordance with various embodiments, the molding of the lower portion of the display lens 205 and the cavity surface of the first housing layer 210 is done using overmolding, insert-molding, two-shot molding and other molding techniques known in the art. The robust bond between the display lens 205 and the first housing layer 210 gives primary sealing protection to the display system 200 against dust, water, and other fluids.

FIG. 3B is a cross sectional view 350 illustrating bond formation between the display lens 205 and the second housing layer 215 of display system 200 in accordance with some embodiments. As shown in FIG. 3B, the second housing layer 215 is attached to the first housing layer 210, through the use of molding techniques. An upper portion 315 of the flange 225 fits tightly between the first housing layer 210 and the second housing layer 215 of the display system 200. In order to achieve this tight fit, the second housing layer 215 is provided with an upper cavity surface 320 within which the upper portion 315 of the flange 225 is retained. Thus, the lower cavity surface 305 and the upper cavity surface 320 form a cavity 340 within which the flange 225 is retained.

A bond is formed between the upper portion 315 of the flange 225 and the second housing layer 215 by molding the upper portion 315 of the flange 225 with the second housing layer 215. In accordance with some embodiments, only a portion of the upper portion 315 of the flange 225, and not the complete upper portion 315 of the flange 225, is inserted into the second housing layer 215 for molding in order to prevent any damage to the edge(s) or the display area as described previously. The bond is superior to that of previous approaches because a chemical bond is formed between the ESD material of the display lens 205 and the antistatic material of the second housing layer 215 during molding process. Upon molding, the antistatic material of the second housing layer 215 forms a bridging path with the layer of ESD material on the display lens 205 for discharge of a charge on the display lens 205 in order to provide ESD protection to the display system 200. The second housing layer 215 of the display system 200 also provides additional sealing protection to the display system 200 from dust, water and other fluids.

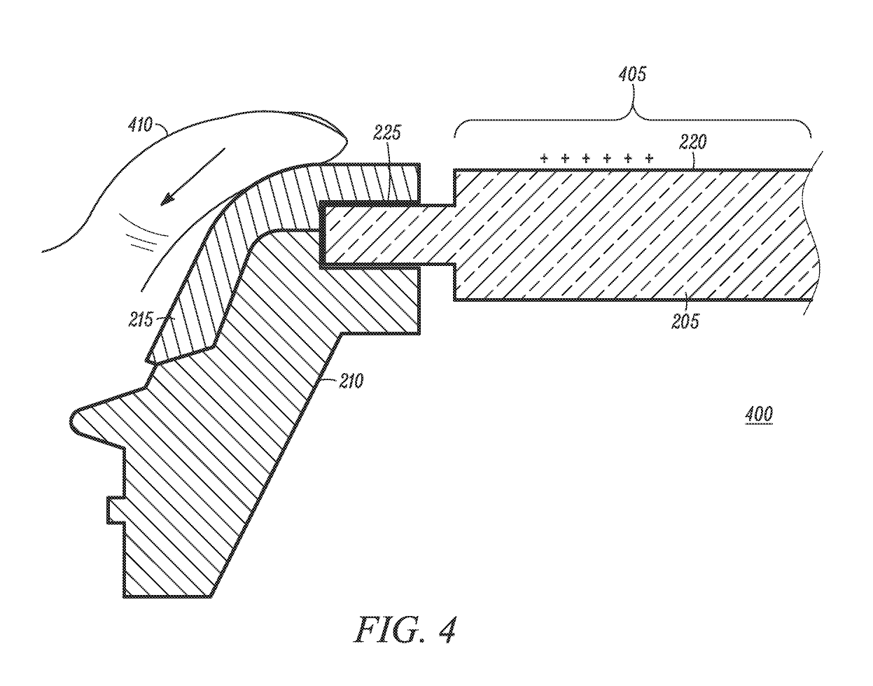

FIG. 4 is a cross sectional view 400 of the display system 200 illustrating a discharge path for an electrostatic charge accumulated on the surface 405 of the display lens 205 in accordance with some embodiments. The display lens 205, coated with the layer of ESD material 220 is mounted between a first housing layer 210 and a second housing layer 215 of the display system 200. The electrostatic discharge material coating on the display lens 205 forms an electrically conductive path with the antistatic material of the second housing layer 215 to allow dissipation of the charge accumulated on the display lens 205. With such arrangements, whenever a user 410 touches the outer housing 215 of the display system 200 with his bare hand, the charge flows from the outer housing 215 to the user and eventually to the ground, thereby providing surface ESD protection. In accordance with some embodiments, a conductive path is formed for the flow of charge from the display lens 205 to the ground via the second housing layer 215 and the user's hand 410.

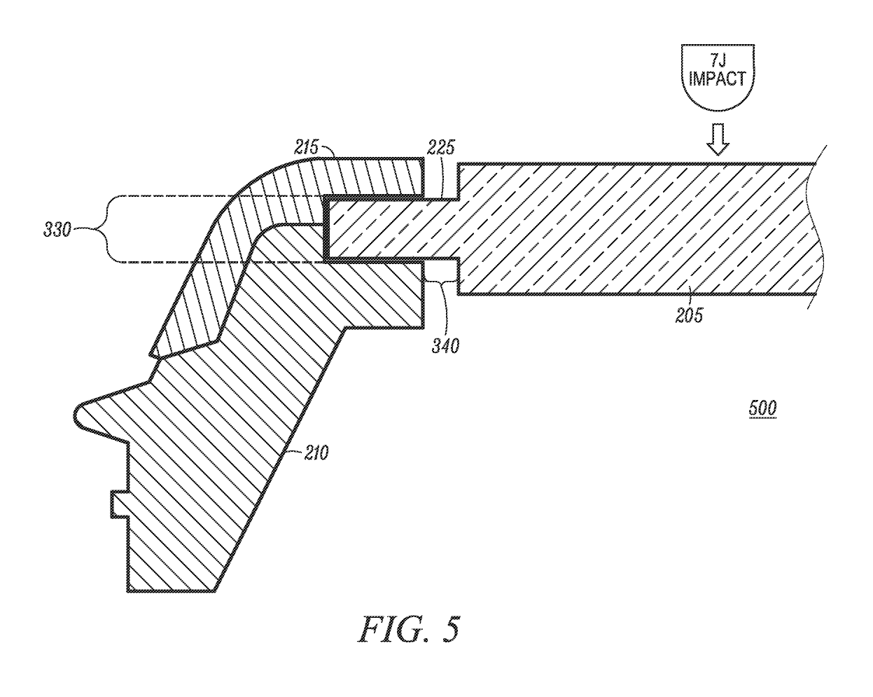

FIG. 5 is a cross-sectional view 500 of the display system 200 receiving a high impact force in accordance with some embodiments. The assembly provides a cavity 330 formed between the first housing layer 210 and the second layer 215 within which the flange 25 is retained. In accordance with some embodiments, only a portion of the flange 225 and not the complete flange is inserted in the cavity 330 thereby creating the gap 340. The gap 340 provides tooling shut off by preventing the edge(s) or display area from being damaged either during tooling or under later impact conditions. The robust joint, formed by molding of the first housing layer 210 and the second housing layer 215, provides structural support to the display lens 205 to withstand at least an impact force of 7J. In accordance with some embodiments, the robust joint between the lower portion 310 of the flange 225 and the lower cavity surface 305 of the first housing layer 210 also provides primary sealing protection to the display system 200 against dust, water and other fluids.

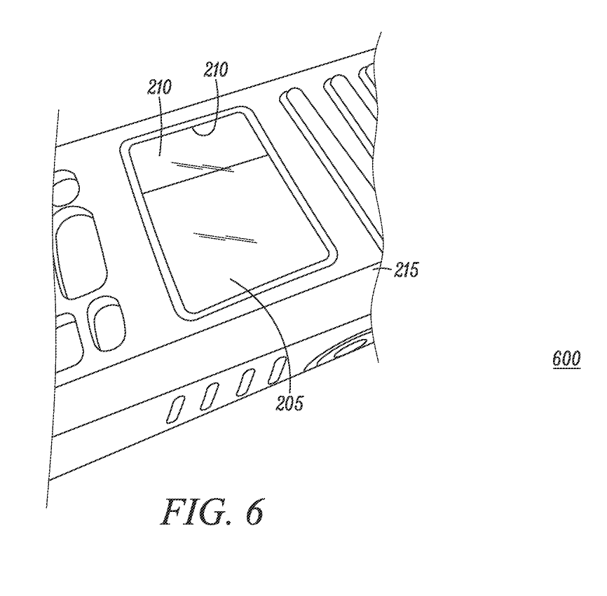

FIG. 6 shows a pictorial view of a communication device 600 incorporating the display system 200 discussed above in accordance with some embodiments. The communication device 600 includes the display lens 205, the first housing layer 210 formed of an insulative material and the second housing layer 215 formed of an antistatic material. The display lens 205 of the communication device 600 is bonded between the first and second housing layers 210, 215 as previously described. The molded bond coupling the first and second housing layers 210, 215 to each other and coupling the first and second layers to the lens provide for a housing having an integrated form factor. If desired, the first and second housing layers 210, 215 of the integrated form factor can be formed of contrasting colors which can be advantageous to products utilized in ruggedized public safety market. The display lens 205 is provided with the flange 225 (shown in FIG. 2) to tightly fit into the first housing layer 210 and the second housing layer 215 of the communication device 600. In accordance with some embodiments, both the first housing layer 210 and the second housing layer 215 of the communication device 600 are provided with lower cavity surface 305 and the upper cavity surface 320 (shown in FIGS. 3A and 3B) which form an overall cavity 330 for insertion of the flange 225. In accordance with some embodiments, only a portion of the flange 225 is inserted into the cavity 330. A gap 340 is left to prevent the edge(s) or display area from being damaged either during tooling or under later impact conditions.

In accordance with the various embodiments, the robust joint between the portion of the flange 225 and the first housing layer 210 provides primary sealing protection and robustness to the display system 200, thereby allowing the display lens 205 to withstand at least an impact force of 7J. Additionally, the display lens 205 being coated with the layer of ESD material provides an electrically conductive path for electrostatic discharge from the display lens 205. The bonding of the display lens with the second housing layer 210 as previously described forms an electrical bridge or electrical path between the antistatic material of the second housing layer 215 thereby providing a path to discharge electrostatic energy. With such an arrangement, whenever the user touches the communication device 600 with his bare hand, the charge accumulated on the display lens 205 flows through the user's hand to the ground via the electrical bridge path between the display lens 205 and the second housing 215 thus providing surface ESD protection.

The display system formed in accordance with the various embodiments provide surface ESD protection to the communication devices in addition to providing sealing protection from dust, water and other fluids. The molding of the display lens between the two housing layers in accordance with the various embodiments assures robustness at the display lens to withstand at least 7J steel ball impact force without jeopardizing the sealing performance of the display system of the communication device. The improved bond and the elimination of piece parts provide an integral assembly well suited for the portable communication device products.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An assembly for coupling a display window to a communication device, the assembly comprising:
a display window coated with an electrostatic discharge (ESD) layer, the display window comprising a flange about its perimeter;
a first housing layer formed of an insulative material providing structural support to the display lens; and
a second housing layer formed of an antistatic material providing an electrical path for discharge of a charge in response to accumulation of the charge on the display windows, wherein at least a portion of the flange is retained between the first housing and the second housing and a molded bond is formed such that the ESD layer of the display window is in contact with the antistatic material of the second housing.

2. The assembly of claim 1, wherein the ESD layer is a conductive coating or static dissipative coating.

3. The assembly of claim 1, wherein the ESD layer of the display window forms an electrically conductive path with the antistatic material of the second housing layer to allow dissipation of the charge.

4. The assembly of claim 1, wherein the ESD layer has a surface resistivity in range of 10²-10¹¹ ohm/sq.

5. The assembly of claim 1, wherein the first housing layer provides structural support to the display window to withstand a standard predetermined impact.

6. The assembly of claim 1, wherein the first housing layer forms a joint with the display window to give primary sealing protection against dust and water to the assembly.

7. The assembly of claim 1, wherein a chemical bond is formed between the flange, the insulative material of the first housing layer and the antistatic material of the second housing layer.

8. The assembly of claim 1, wherein the antistatic material is an antistatic plastic.

9. The assembly of claim 1, wherein the antistatic material has a surface resistivity in range of 10²-10¹¹ ohm/sq.

10. The assembly of claim 1, wherein the antistatic material is made from a mixture of polycarbonate and carbon powder or a mixture of polycarbonate and stainless steel filler.

11. (canceled)

12. (canceled)

13. (canceled)

14. (canceled)

15. (canceled)

16. (canceled)

17. (canceled)

18. (canceled)

19. (canceled)

20. (canceled)

21. The assembly of claim 1, wherein only a portion of the flange and not the complete flange is retained between the first housing and the second housing and the bond is formed such that a gap is present between the perimeter of the display window and the first and the second housing.

22. The assembly of claim 1, wherein the first housing comprises a lower cavity to retain and hold a part of lower portion of the flange for molding the retained portion of the flange with the first housing.

23. The assembly of claim 22, wherein the second housing comprises an upper cavity to retain and hold a part of the upper portion of the flange, for molding the retained portion of the flange with the second housing.

24. The assembly of claim 23, wherein the lower cavity and the upper cavity form a cavity in within which the flange is retained and further wherein the second housing is attached to the first housing using molding techniques.
